(19) United States
(12) Patent Application Publication
(10) Pub. No.: US 2007/0067133 A1
(43) Pub. Date: Mar. 22, 2007

(54) Setup file generating system

(75) Inventors: Takuya Abe, Shiojiri-shi (JP); Kazuhito Gassho, Shiojiri (JP); Kazuyuki Mitsui, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/523,552

(22) Filed: Sep. 20, 2006

(30) Foreign Application Priority Data
Sep. 21, 2005 (JP) 2005-273228

(51) Int. Cl. G01D 1/00

(52) U.S. Cl. 702/127

(57) ABSTRACT

The setup file generating system comprises a device monitoring unit configured to monitor a target device according to a monitoring setup file; and a setup file generating unit, coupled to the device monitoring unit via a network, for generating the monitoring setup file. The device monitoring unit includes an information transmission section configured to transmit, to the setup file generating unit, first information held in the device monitoring unit, and second information held in the target device. The setup file generating unit includes an information receiving section configured to receive the first and second information from the device monitoring unit; and a setup file generation executing section configured to generate a monitoring setup file based on the received first and second information.

### CROSS REFERENCE TO RELATED APPLICATIONS

The present application claims the priority based on Japanese Patent Application No. 2005-273228 filed on Sep. 21, 2005, the disclosure of which is hereby incorporated by reference in its entirety.

### BACKGROUND OF THE INVENTION

1. Field of the Invention

The present invention relates to technologies for generating setup files used for acquiring specific monitoring information from devices.

2. Description of the Related Art

Recent years have seen increasing popularity of device management systems wherein devices and management servers for controlling these devices are connected over a network. These device management systems manage devices through control servers which receive from the devices various monitoring information such as alerts for failure events, and the state of depletion of consumable objects used in the devices.

As this type of device management system, there is, for example, a system that has been proposed wherein multiple devices, such as printers and scanners, are connected to a control server through a local area network or the internet.

In order to acquire specific monitoring information from a device in a device management system wherein devices send monitoring information to control servers, it is necessary to establish information that defines the type of monitoring information to be acquired, and that indicates the location where this monitoring information is stored. Given this, this information is formed into a setup file, and in some cases is stored in advance in each device.

Here, when it comes to the information as to what sort of monitoring information is to be acquired (that is, the “monitoring items”), a device control service, for example, that uses a device management system may be modified after the start of device management through, for example, a modification in the details of the agreement between the device management service provider and the individual commissioning the device control.

Moreover, it is possible to update the information such as where the monitoring information is stored, when, for example, a device is swapped for a device of a different model due to, for example, a device failure. This is because the monitoring information is stored in a different location for each device model.

Given this, when there has been a change in the monitoring items or in the storage location of the monitoring information to be acquired, there is the need to generate a new setup file in accordance with the changes, and to store this new setup file in place of the previous setup file.

Conventionally, when this type of new setup file has been generated and stored in a device, a maintenance technician, or the like, has connected a setup PC to the device to be monitored (such as a printer), and, depending on the model of device after the change, and depending on the details of the agreement after the change, has setup the monitoring items, the storage locations of the monitoring information to be acquired, and the like, using the setup PC to generate the new setup file.

Consequently, when the number of types of target devices is large, such setup file generating work is extremely time consuming and laborious. Moreover, it is possible for the maintenance technician to mistake the model of device after switching, and to generate an unsuitable setup file. Moreover, there has also been a problem in that it has been necessary for the maintenance technician to travel to the location wherein the device is installed even when there has been a change in only the details of the agreement, without a change in the device, which is not only inconvenient, but also involves a time delay until changes in the details of the agreement are reflected into the equipment.

### SUMMARY OF THE INVENTION

An object of the present invention is to provide a technology wherein, if there is a change in the device model or a change in the monitoring items in a device management system, a setup file is generated according to these changes and stored in the target device using a simple method.

According to an aspect of the present invention, there is provided a setup file generating system comprising: a device monitoring unit configured to monitor a target device according to a monitoring setup file; and a setup file generating unit, coupled to the device monitoring unit via a network, for generating the monitoring setup file. The device monitoring unit includes an information transmission section configured to transmit, to the setup file generating unit, first information held in the device monitoring unit, and second information held in the target device. The setup file generating unit includes: an information receiving section configured to receive the first and second information from the device monitoring unit; and a setup file generation executing section configured to generate a monitoring setup file based on the received first and second information.

In the setup file generating system, the device monitoring unit sends the first information and the second information to the setup file generating unit, and the setup file generating unit generates the monitoring setup file based on the received first and second information, so that if there is a change in the first information and/or the second information, it is possible to generate a new monitoring setup file in accordance with the first and second held information after the change.

According to another aspect of the present invention, a device monitoring unit for monitoring a target device according to the monitoring setup file comprises: a storage for storing the monitoring setup file and first generation time information that indicates a generation time of the monitoring setup file; an acquiring section configured to acquire, from the setup file generating unit, a new monitoring setup file generated newly by the setup file generating unit, and second generation time information indicating a generation time of the new monitoring setup file. The device monitoring unit further comprises a time determining section configured to determine which, of the generation time indicated by the first generation time information, or the generation time indicated by the second generation time information, is more recent; and an update section configured to update the monitoring setup file with the new monitoring setup file when the time determining section has determined that the setup time indicated by the second generation time information is the more recent.

The time determining section in the device monitoring unit will determine that the generation time indicated by the second generation time information is more recent, or in other words, that the generation time of the newly generated setup file is more recent, when a new setup file has been generated in the setup file generating unit. Consequently, when the time determining section has made such a determination, the updating section can update the monitoring setup file in the device monitoring unit based on the new monitoring setup file, thus making it possible for the device monitoring unit to monitor the target device based on the new generated setup file.

Note that the present invention is not limited to the form of a device invention of the setup file generating system, setup file generating unit, and/or device monitoring unit described above, but instead may be embodied as a process invention as a setup file generating method. Moreover, the present invention may also be embodied in the form of a computer program for implementing these methods or units, in the form of a computer readable medium on which such a computer program is recorded, in the form of a information signal incorporated within a carrier wave and including the computer program, or in a variety of other forms.

When the present invention is structured as a computer program or as a recording medium recorded with this computer program, the present invention may be structured as the entirety of the program for controlling the setup file generating system, the setup file generating unit, and/or the device monitoring unit, or may be structured from only those parts that achieve the functions of the present invention. Moreover, as the recording medium, a ROM cartridge, a punch card, a barcode or other printed materials whereon symbols are printed, an internal memory device (a memory such as a RAM, a ROM, or the like) within a computer, an external storage device, or any of a variety of computer-readable media may be used.

These and other objects, features, aspects, and advantages of the present invention will become more apparent from the following detailed description of the preferred embodiments with the accompanying drawings.

### BRIEF DESCRIPTION OF THE DRAWINGS

FIG. 1 schematically illustrates the structure of a device management system according to one embodiment according to the present invention;

FIG. 2 schematically illustrates the structure of the printer PRT1 in FIG. 1;

FIG. 3 schematically illustrates the structure of the monitoring server SV in FIG. 1;

FIG. 4 shows the content of the master database provided in the monitoring server SV;

FIG. 5 shows the content of the monitoring item table provided in the monitoring server SV;

FIG. 6 shows the content of the model information database provided in the monitoring server SV;

FIG. 7 shows the content of the monitoring setup file MSF used when maintenance service is provided for a model “LP-9000C” printer; and

FIG. 8 is a flowchart illustrating the procedures in the monitoring setup file generating process in an embodiment.

### DESCRIPTION OF THE PREFERRED EMBODIMENT

A preferred embodiment of the present invention will be explained in the following sequence.

A. Embodiment:

A1. System Overview
A2. Monitoring Procedure Overview
A3. Monitoring Setup File Generating Procedure when the Printer Body has Been Replaced
A4. Monitoring Setup File Generating Procedure when the Details of the Service Agreement have Been Changed
A5. Effects of the Embodiment
   B. Modified Examples.
   A. Embodiment
   A1. System Overview

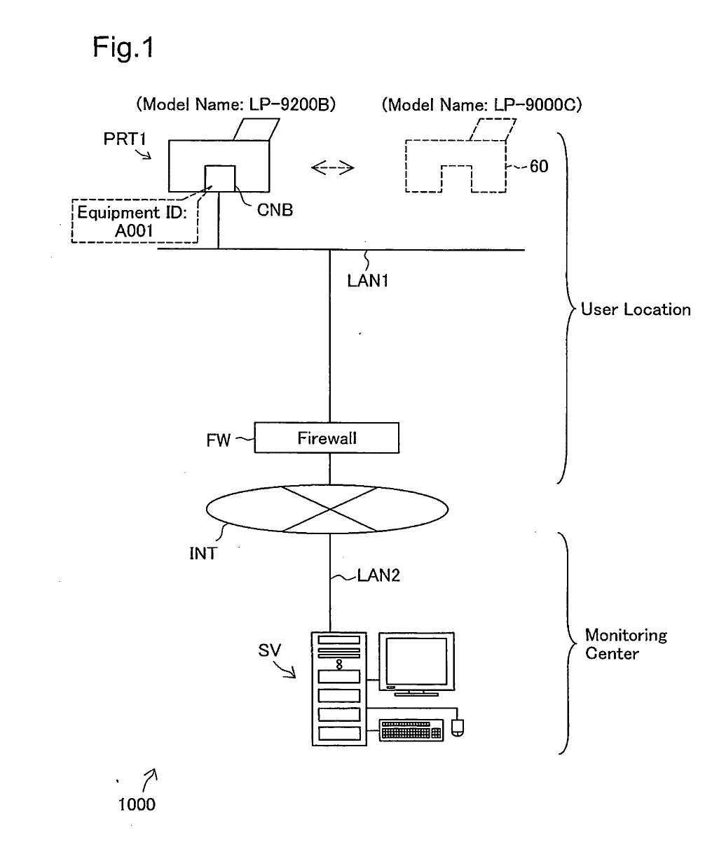

FIG. 1 is an explanatory diagram illustrating the schematic structure of a device management system as one embodiment according to the present invention. The device management system 1000 comprises a printer PRT1, installed at the user location, and a monitoring server SV, installed at the monitoring center of the device management service provider.

At the user location, the printer PRT1 is connected to a local area network LAN1.

The printer PRT1 is provided with a custom network board CNB, which is connected to a local area network LAN 1. The local area network LAN1 is connected to the internet INT through a firewall FW.

At the monitoring location, the monitoring server SV is connected to a local area network LAN2, which is connected to the internet INT.

In this device management system 1000 the monitoring information of specific monitoring items, such as the state of use of the printer PRT1, and error events, are sent from the printer PRT1 to the monitoring server SV, and the information is accumulated in the monitoring server SV to perform the monitoring.

The firewall FW is set up so as to reject connection requests to the printer PRT1 through the internet INT in order to avoid illegal access to the printer PRT1 from the outside through the internet INT. Accordingly, in the device management system 1000, the printer PRT1 sends a connection request to the monitoring server SV to establish the connection between the printer PRT1 and the monitoring server SV, after which the monitoring information is sent to the monitoring server SV.

The device management service provider of the device management system 1000 is able to provide maintenance service to the printer PRT1. For example, in the monitoring server SV, when monitoring information is received regarding a fault that has occurred in the printer PRT1, it is possible to provide service based on this monitoring information, such as repairing the fault or replacing with a replacement machine.

Moreover, the device management service provider can use the device management system 1000 to provide an accounting service where there is a charge depending on the state of use of the printer PRT1 (for example, the number of pages that have been printed or the amount of toner used).

The monitoring information is acquired in accordance with the monitoring setup file stored in the custom network board CNB in the printer PRT1, and sent to the monitoring server SV. This monitoring setup file includes the storage location of the monitoring information of specific monitoring items, where the file will differ depending on printer model and on the type of service provided (maintenance service/accounting service).

In the device management system 1000, when there is a change to printer model PRT1 or to the type of service provided, the monitoring server SV generates a new monitoring setup file according to the change, and sends the file to the custom network board CNB.

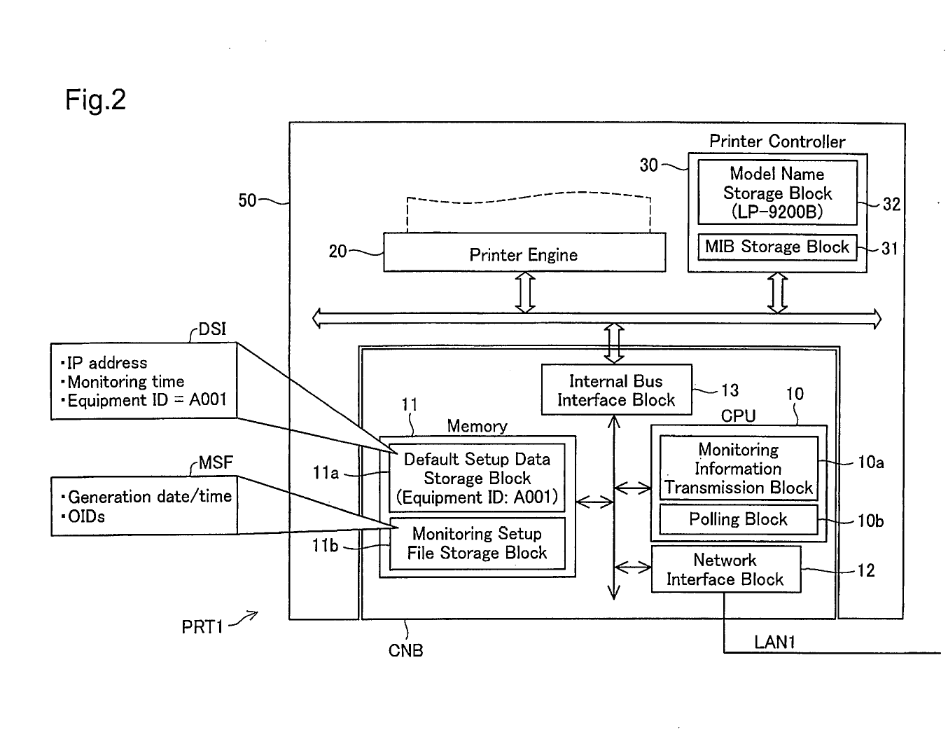

FIG. 2 schematically illustrates the structure of the printer PRT1.

The printer PRT1 is a monochrome printing, and is provided with a printer body 50 and a custom network board CNB that can be installed removably in the printer body 50. The printer body 50 is provided with a printer engine 20 and a printer controller 30, where each is connected to an internal bus.

Note that the model name for the printer PRT1 is “LP-9200B,”and this indicates the model of the printer body 50.

The printer engine 20 comprises a set of hardware for printing on paper, such as a toner cartridge and a photosensitive drum. The printer controller 30 is a computer having a CPU and a memory, not shown, and can control the printer engine 20 according to print job information received over the local area network LAN1 to perform printing.

The printer controller 30 compiles a variety of information regarding the printer body 50, such as the type of toner in the printer engine 20, and stores this information in a form known as the MIB (management information base). The memory (not shown) in the printer controller 30 is provided with an MIB storage block 31 as the MIB storage destination.

Some items stored in the MIB are defined by the standards regarding the printer body, and other items are defined independently by the manufacturer. These items can be controlled in a tree structure based on the manufacturer, the model, the type of item, and so forth, where each is assigned an identification number, known as an object ID (OID) that indicates the manufacturer, the model, and the type of item.

In addition to the MIB storage block 31, the memory of the printer controller 30 is also provided with a model name storage block 32 for storing the model name of the printer body 50. The model name storage block 32 stores the model name, “LP-9200B” of the printer body 50 prior to shipping.

The custom network board CNB comprises a CPU 10, a memory 11, a network interface block 12, and an internal bus interface block 13, where each are connected to an internal bus.

The network interface block 12 comprises an interface for connecting the local area network LAN1 to the custom network board CNB. The internal bus interface block 13 comprises an interface for connecting the internal bus of the printer body 50 to the internal bus of the custom network board CNB.

The memory 11 is provided with a default setup data storage block 11a and a monitoring setup file storage block 11b. The default setup data storage block 11a is an area that stores default setup information DSI.

The default setup information DSI is used by the custom network board CNB for acquiring the monitoring information and for sending the monitoring information to the monitoring server SV; DSI is not dependent on the printer model or on the type of service provided. Specifically, DSI includes the network settings (such as the IP address assigned to the printer PRT1, the subnet mask, and the like), the timing for collecting the monitoring information (such as 12:00 am), and the equipment ID, described below.

The monitoring setup file storage block 11b stores the monitoring setup file MSF, which is dependent on the printer model and on the type of service provided.

Note that the default setup information DSI and the monitoring setup file MSF in the initial state are stored, respectively, in the default setup data storage block 11a and the monitoring setup file storage block 11b when the printer PRT1 is installed. Specifically, when the printer PRT1 is installed, the installation technician sets up various types of information by connecting a setup PC to the printer PRT1, to store the default setup information DSI and the monitoring setup file MSF in the printer.

Computer programs for the monitoring procedure are stored in the memory 11, and by reading out and executing the programs from the memory 11, the CPU 10 is able to function as a monitoring information transmission block 10a and a polling block 10b.

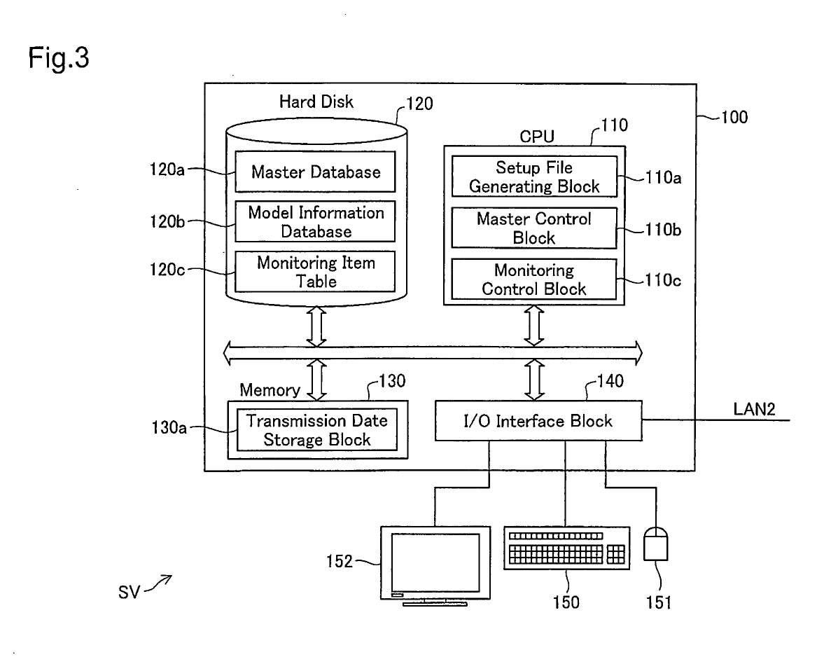

FIG. 3 schematically illustrates the structure of the monitoring server SV illustrated in FIG. 1.

The monitoring server SV includes a computer 100, which has a CPU 110, a hard disk 120, a memory 130, and an I/O interface block 140, each of which connected to an internal bus. The monitoring server SV is provided with a keyboard 150 and a mouse 151 as data input devices, and a display 152 as an image output device.

The I/O interface block 140 comprises a set of interfaces for connecting, to the computer 100, the keyboard 150, mouse 151, display 152, and local area network LAN2.

In the computer 100, an application program runs under a specific operating system. Note that this operating system is a combination of various types of drivers, and control the keyboard 150, mouse 151, and display 152.

When the application program is launched and loaded into the memory 130, the CPU 110 executes the application program to function as a setup file generating block 110a, a master control block 110b, and a monitoring control block 110c.

The memory 130 includes a transmission data storage block 130a. The hard disk 120 includes a master database 120a, a model information database 120b, and a monitoring item table 120c.

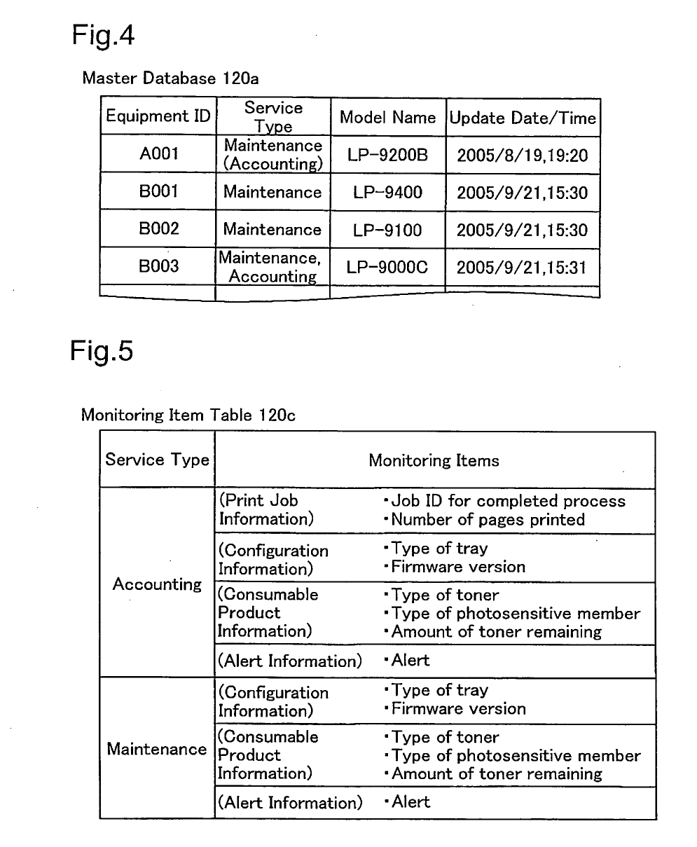

FIG. 4 shows the content of the master database 120a stored in the hard disk 120 of the monitoring server SV.

The master database 120a comprises records for each equipment ID, associated with service types, model names, and update dates.

The equipment ID is an identification for the maintenance and/or accounting service agreement, and is setup in advance in the custom network board CNB (FIG. 2). Since the equipment ID is an identification for the service agreement, it remains the same even if the custom network board CNB is replaced. The equipment ID is setup in the custom network board CNB that is provided in the individual printer for which service is provided, after a maintenance and/or accounting service agreement is established.

When a equipment ID is setup for each of the custom network boards, the technician at the monitoring center is able to use the keyboard 150 and the mouse 151 provided at the monitoring server SV to input the equipment ID, the type of service defined in the agreement, and the printer model for which the service will be provided, to make a new record to the master database 120a. At this time, the date and time at which the record is generated will be recorded automatically in relation to the equipment ID.

Specifically, if the equipment ID “A001” is assigned to the custom network board CNB that is installed in a printer PRT1, and there is a maintenance service agreement for the printer PRT1, then a new record will be added to the top of the master database 120a, as shown in FIG. 4, with the equipment ID “A001”, the service type “maintenance,” and the model name “LP-9200b,” and the update date/time “2005/08/19, 19:20.”

Note that, as described above, the equipment ID does not indicate the custom network board CNB itself, but indicates the service to be provided. Specifically, the aforementioned equipment ID “A001,” for example, is not an identification for the custom network board CNB itself, but rather it is an identification indicating “maintenance service for one printer at the customer location.”

Consequently, even if the custom network board CNB is to be replaced with another custom network board, because of a failure or the like, this same equipment ID “A001” will be assigned to the replacement custom network board CNB, and the maintenance service will be continued to be provided with the printer PRT1.

If the printer body 50 of the printer PRT1 is to be replaced with another printer body, due to a failure or the like, the custom network board CNB will be transferred to the replacement printer body, and the provision of maintenance services will continue with this printer, having the replacement body.

FIG. 5 shows the content of the monitoring item table 120c provided on the hard disk 120 of the monitoring server SV.

The monitoring item table 120c lists the monitoring items that are required for providing each of the services (accounting or maintenance).

Specifically, the monitoring items for the maintenance service comprises: configuration information including the type of tray and the firmware version; consumable product information including the type of toner, the type of photosensitive member, and the amount of toner remaining; and alert information including alerts. The monitoring items for the accounting service comprises print job information including completed job IDs and number of copies printed, in addition to the configuration information, consumable product information, and alert information.

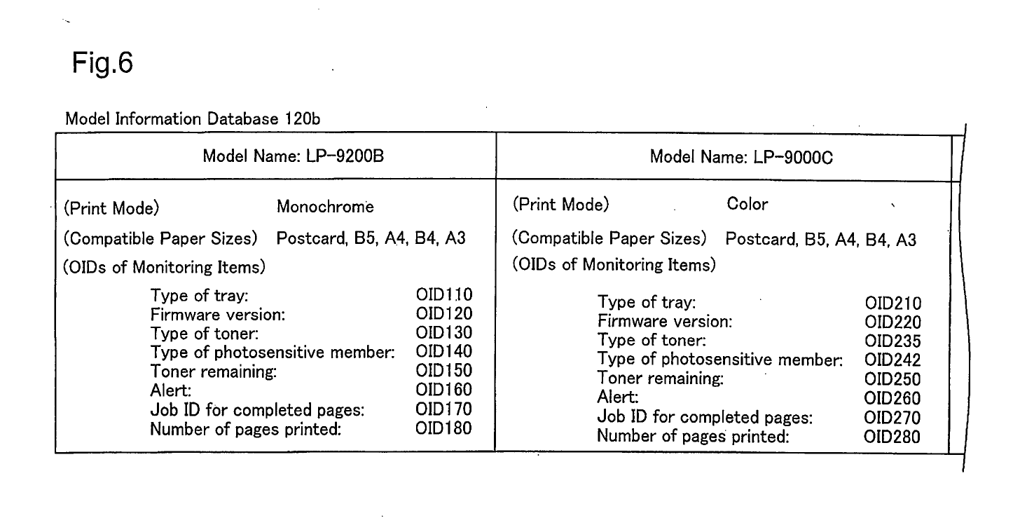

FIG. 6 shows the content of the model information database 120b that is provided on the hard disk 120 of the monitoring server SV.

The model information database 120b stores information for each printer model, such as available print modes (monochrome and/or color), appropriate paper sizes, and various Object IDs of the monitoring items. Note that the OIDs are actually represented by numbers separated by periods, such as “1.4.2.2.1.3,” but for ease in explanation, these will be indicated in the form of, for example, OID110 or OID280 in the drawings.

The monitoring items indicated by the OIDs within the model information data base 120b includes both the items associated with the maintenance service and the items associated with the accounting service, which are defined in the monitoring item table 120c (FIG. 5). Note that the monitoring items associated with the maintenance service are all included in the monitoring items associated with the accounting service, and so, in effect, the various monitoring items associated with the accounting service will be listed in the data base 120b.

Because the OID indicates the manufacturer, the model, and the type of item, different OIDs will be assigned for identical monitoring items if the model is different,. In the example of FIG. 6, for the monitoring item “type of tray”, “OID110” is assigned for the model name “LP-9200b”, while “OID 210” is assigned for the model name “LP-9000c.”

Given this, the monitoring setup file MSF (FIG. 2) includes these OIDs for indicating the storage locations of the monitoring information associated with the monitoring items.

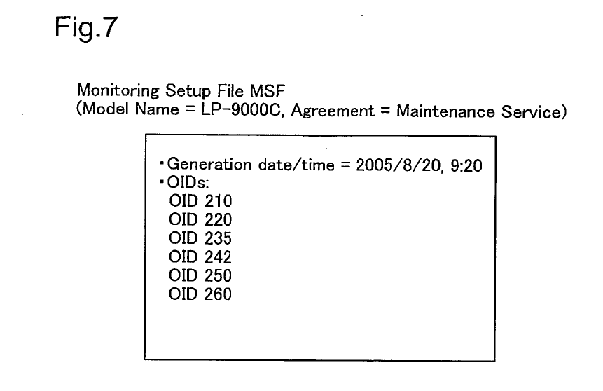

FIG. 7 shows the content of the monitoring setup file MSF that is used when maintenance service is provided with the target printer having the model name of “LP-9000C.”

Let us consider the monitoring setup file MSF for the target printer with the model name “LP-9000C.” As shown in FIG. 5, the monitoring items associated with the maintenance service includes the type of tray, the firmware version, the type of toner, the type of photosensitive member, the amount of toner remaining, and alerts. As shown in FIG. 6, the OIDs assigned to LP-9000C for these monitoring items are, respectively, OID210, OID220, OID235, OID242, OID250, and OID260.

Consequently, in this case, the monitoring setup file MSF will list each of these OIDs, as shown in FIG. 7. Note that the monitoring setup file MSF records, in addition to the OIDs for the monitoring items, the generation date/time of the monitoring setup file MSF, as a file property.

Note that the monitoring server SV corresponds to the setup file generating unit in the claims; the custom network board CNB corresponds to the device monitoring unit in the claims; the master database 120a and the monitoring item table 120c correspond to the first table in the claims; the model information database 120b corresponds to the second table in the claims; and the equipment ID corresponds to the service agreement identification information in the claims.

The setup file generating block 110a in the server SV (FIG. 3) functions as the setup file generation executing section of the setup file generating unit in the claims. The monitoring control block 110c functions as the information receiving section, the storage location determining section, the time determining section, and the setup file transmission section of the setup file generating unit in the claims. The hard disk 120 and memory 130 function as the storage of the setup file generation unit in the claims. The monitoring information transmission block 10a of the CNB (FIG. 2) functions as the information transmission section of the device monitoring unit in the claims.

A2. Monitoring Procedure Overview

An overview of the monitoring process in the device management system 1000 will be explained next.

In the printer PRT1 shown in FIG. 2, the monitoring information transmission block 10a reads out the monitoring setup file MSF stored in the monitoring setup file storage block 11b, and the monitoring timing included in the default setup information DSI that is stored in the default setup data storage block 11a. The monitoring information transmission block 10a then acquires from the MIB in the MIB storage block 31, which is provided in the printer controller 30, the monitoring information corresponding to the monitoring items listed in the monitoring setup file MSF.

The monitoring information transmission block 10a establishes the connection with the monitoring server SV according to the network settings included in the default setup information DSI, and then sends the acquired monitoring information through the local area network LAN1 and the internet INT to the monitoring server SV.

In the monitoring server SV shown in FIG. 3, the monitoring control block 110c receives the monitoring information, sent from the printer PRT1, and stores this monitoring information in the hard disk 120. When the monitoring information for the printer PRT1 is stored in this way to the hard disk 120 of the monitoring server SV, maintenance or accounting is performed based on the monitoring information thus stored.

Here the printer PRT1 not only sends the aforementioned monitoring information, but also performs periodic polling of the monitoring server SV, as part of the monitoring process. This polling is performed to send, from the monitoring server SV to the printer PRT1, commands such as reset commands, and information such as a new monitoring setup file MSF that is generated.

The polling from the printer is used because, as described above, the fire wall FW (FIG. 1 ) prevents the monitoring server SV from establishing a connection between the monitoring server SV and the printer PRT1, so the monitoring server SV cannot initiate the transmission of commands, such as the reset command, and information, such as the monitoring setup file MSF, to the printer PRT1.

In the printer PRT1 shown in FIG. 2, the polling block 10b establishes a connection with the monitoring server SV at specific time intervals included in the default setup information DSI. In the monitoring server SV shown in FIG. 3, the information that is to be sent to the printer PRT1 is stored in the transmission data storage block 130a provided in the memory 130. When a connection is established between the monitoring server SV and the printer PRT1 through polling, the monitoring control block 110c reads out information from the transmission data storage block 130a and sends this information through the local area network LAN2 and the internet INT to the printer PRT1.

A3. Monitoring Setup File Generating Process when the Printer Body has Been Replaced

The monitoring setup file MSF generating process will be explained first for the case wherein the printer body has been changed.

It is assumed that in the monitoring setup file generating process an agreement has been made between the user and the device management service provider for maintenance service of the printer PRT1, shown in FIG. 1, and that “A001” has been assigned as the equipment ID of the custom network board CNB. Given this, in the monitoring server SV, a new record is added to the master database 120a for the equipment ID “A001,” as shown in FIG. 4. The monitoring server SV stores the monitoring information that is sent from the printer PRT1 through the monitoring process described above.

The assigned equipment ID “A001” is stored in the default setup data storage block 11a (FIG. 2), as a part of the default setup information DSI. The monitoring items for the maintenance service are listed as the Object IDs, that are associated with the model name of the printer body 50, in the monitoring setup file MSF in the monitoring setup file storage block 11b.

Let us consider the case wherein the printer body 50 of the printer PRT1 has been replaced with another printer body 60 (model=LP-9000C) shown by the dotted line in FIG. 1. Note that this printer body 60 is of a model that can print in color as well, and when compared to the configuration of the printer body 50 of the printer PRT1 shown in FIG. 2, the configuration of the printer body 60 is different in that the printer engine is for color printing, but the printer controller is of an identical configuration. The model name “LP-9000C” is stored in advance in the model name storage block 32 of the printer body 60.

In this case, the maintenance technician removes the custom network board CNB from the printer body 50 of the printer PRT1 at the user site, and installs the printer body 60 and connects the local area network LAN1. Note that the printer wherein the custom network board CNB is installed in the printer body 60 will be termed “printer PRT3” below.

The default setup information DSI and monitoring setup file MSF that were stored when the custom network board CNB was installed in the printer body 50 still remain unchanged in the memory 11 of the custom network board CNB. That is, “A001” is stored as the equipment ID, and the monitoring setup file MSF lists the Object IDs of the monitoring items requiring maintenance service for the “LP-9200B” model name of the printer body 50.

The monitoring information transmission block 10a in the board CNB, in this state, attempts to acquire monitoring information from the printer body 60 according to the OIDs for the model name “LP-9200B” registered in the monitoring setup file MSF. The result is that it is not possible to obtain monitoring information for the monitoring items required in the maintenance service for the printer PRT3 with the model name of “LP-9000C.”

On the other hand, at the monitoring center, the master database 120a and the monitoring server SV has not been updated since the printer body 50 was replaced with the printer body 60. That is, the record for the equipment ID “A001” remains as is shown at the top in FIG. 4, and the model name remains “LP-9200B.”

Given this, when the power is turned ON for the printer PRT3 by the maintenance technician at the user site, the custom network board CNB installed in the printer body 60 begins the monitoring setup file generating process described below.

Note that the power is already on for the monitoring server SV, and the monitoring setup file generating process is running in the monitoring server SV. Moreover, when the power supply is turned ON for the printer PRT3, the polling block 10b commences the periodic polling, described above, separate from the monitoring setup file generating process.

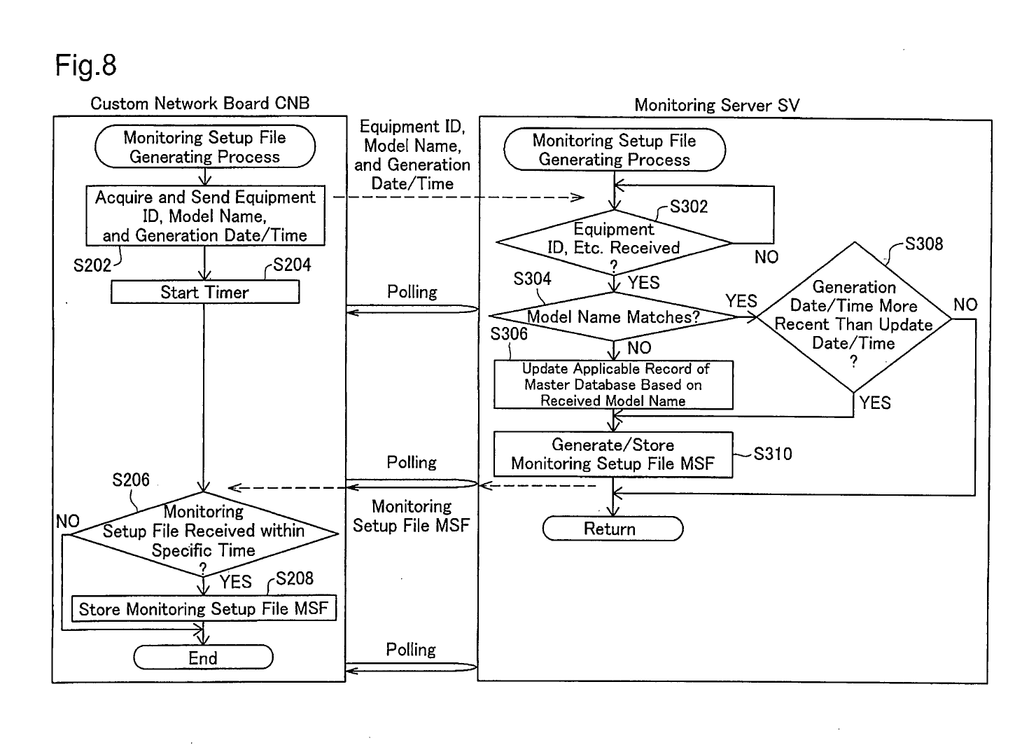

FIG. 8 is a flow chart illustrating the procedure for the monitoring setup file generating process in the present embodiment. In FIG. 8, the left side shows the procedure in the custom network board CNB, and the right side shows the procedure in the monitoring server SV.

When the monitoring setup file generating process is started, then in the custom network board CNB shown in FIG. 2, the monitoring information transmission block 10a reads out the equipment ID from the default setup data storage block 11a, and the model name from the model name storage block 32 of the printer body 60. The monitoring information transmission block 10a further reads out the monitoring setup file MSF stored in the monitoring setup file storage block 11b, to get the generation date/time of the file.

After establishing the connection with the monitoring server SV according to the network settings included in the default setup information DSI, the monitoring information transmission block 10a sends to the monitoring server SV the equipment ID, the model name, and the generation date/time (Step S202). Next, the monitoring information transmission block 10a starts a timer, not shown, (Step S204).

Since “A001” is stored as the equipment ID in the default setup data storage block 11a and “LP-9000C” is stored in the model name storage block 32, this “A001” and this “LP-9000C” are sent to the monitoring server SV along with the generation date/time of the monitoring setup file MSF.

In the monitoring setup file generating process of the monitoring server SV, the monitoring control block 110c determines whether or not the equipment ID, model name, and generation date/time have been received from the printer PRT1 (Step S302). If the decision is that this information has been received, the monitoring control block 110c determines whether or not the received model name matches the model name stored in the record for the equipment ID that has been received, in the master database 120a (Step S304).

When the equipment ID “A001,” the model name “LP-9000C,” and the generation date/time have been received, the monitoring control block 110c determines that the model name “LP-9000C” does not match the model name “LP-9200B” of the record for the equipment ID “A001” in the master database 120a shown in FIG. 4.

When the monitoring control block 110c determines that there is a mismatch in this way, the master control block 110b updates the applicable record of the master database 120a based on the model name that has been received (Step S306).

Specifically, when the received model name is “LP-9000C,” the master control block 110b changes the model name for the record for the equipment ID “A001” in the master database 120a from “LP-9200B” to “LP-9000C” to perform the update. Note that in this case, the update date/time for the record for the equipment ID “A001” is also updated.

Next the setup file generating block 110a generates a new monitoring setup file MSF based on the updated record of the master database 120a (FIG. 4), the monitoring item table 120c (FIG. 5), and the model information database 120b (FIG. 6), and stores the new monitoring setup file MSF in the transmission data storage block 130a (Step S310).

Specifically, when the record for the equipment ID “A001” in the master data base 120a is updated, the setup file generating block 110a references the monitoring item table 120c (FIG. 5) with the service type of “maintenance” to determine the monitoring items for the maintenance service. The setup file generating block 110a further references the model information database 120b (FIG. 6) to determine the Object IDs for the model name “LP-9000C” that correspond to the monitoring items that have been determined. Then the setup file generating block 110a generates the new monitoring setup file MSF listing the OIDs thus determined, and stores this monitoring setup file MSF in the transmission data storage block 130a.

Note that the contents of the monitoring setup file MSF that is generated in this are the same as the contents illustrated in FIG. 7 except the generation date/time.

Here, as described above, the polling block 10b in the printer PRT3 performs polling at regular intervals, and when a connection has been established between the printer PRT3 and the monitoring server SV after the new monitoring setup file MSF has been stored in the transmission data storage block 130a in the server SV, then the monitoring control block 110c in the server SV sends the new monitoring setup file MSF to the printer PRT3.

In the printer PRT3, the monitoring information transmission block 10a, after starting the timer in the process in Step S204, described above, determines whether or not a monitoring setup file MSF has been received from the monitoring server SV during a specific time interval prior to the timer timing out (Step S206).

If a monitoring setup file MSF has been received from the monitoring server SV within the specific time interval, then the monitoring information transmission block 10a of the printer stores the received monitoring setup file MSF in the monitoring setup file storage block 11b, overwriting the monitoring setup file MSF that already exists (Step S208).

Because the result of the monitoring setup file MSF generating process is that the new monitoring setup file MSF, with contents as illustrated in FIG. 7, is stored in the monitoring setup file storage block 11b within the printer, the monitoring information transmission block 10a is able to acquire, from the MIB of the printer body 60, the monitoring information that corresponds to the specific monitoring items required for the maintenance service, and to send the acquired information to the server SV.

A4. Monitoring Setup File Generating Procedure When the Details of the Service Agreement Have Been Changed

The monitoring setup file generating process when the details of the agreement have been changed will be described next.

Note that the assumptions in this case are the same as the assumptions in the monitoring setup file generating process when the printer body has changed, as described above, and thus detailed explanations thereof will be omitted. Note that it is assumed that the generation date/time of the monitoring setup file MSF stored in the printer PRT1 is “2005/8/20, 9:20” (yy/mm/dd, time).

Given the above conditions, let us consider the case wherein there has been a change in the details of the agreement to provide an accounting service, in addition to the maintenance service, for the printer PRT1.

In this case, in the monitoring server SV at the monitoring center, a maintenance technician updates the record for the equipment ID “A001” in the master database 120a (FIG. 4) to change the service type from “Maintenance” to “Maintenance, Accounting.”

Note that the update date/time for the record for this equipment ID “A001” is overwritten with the date/time of this update. Here the update date/time is overwritten from “2005/8/19, 19:20” to “2005/11/5, 14:00” in the master data base 120a.

In the printer PRT1, the Object IDs for the monitoring items corresponding to the maintenance service remain as they are in the monitoring setup file MSF that exists in the monitoring setup file storage block 11b. In other words, as is shown in the monitoring item table in FIG. 5, OIDs are listed for configuration information, consumable product information, and alert information.

As is also shown in FIG. 5, along with these items, print job information is also added as required information for the accounting service. Because of this, in the current state, the print job information cannot be obtained from the MIB of the printer body 50, making it impossible to provide the accounting service with the printer PRT1.

Note that the power supply to the monitoring server SV is already turned on, and the monitoring setup file generating process is running in the monitoring server SV. At the user location, the printer PRT1 is turned off and on a daily basis.

When the power supply of the printer PRT1 is turned on at the beginning of the workday after the maintenance agreement has been changed, the monitoring setup file generating process is started in the custom network board CNB. Note that when the printer PRT1 is turned on, the polling block 10b starts the periodic polling, independent of the monitoring setup file generating process.

In the below, the processes for the custom network board CNB and the monitoring server SV are the same as the processes illustrated with the flowchart in FIG. 8, and so only a simple explanation will be given regarding the procedures explained for the monitoring setup file generating process that has already been explained above for when the printer body was replaced.

When the monitoring setup file MSF generating process of FIG. 8 is started, the monitoring information transmission block 10a in the printer PRT1 (FIG. 2) sends to the monitoring server SV the equipment ID “A001,” the model name “LP-9200B,” and the monitoring setup file MSF generating date/time “2005/8/20, 9:20” (Step S202), and then a timer, not shown, is started (Step S204).

In the monitoring server SV shown in FIG. 3 the monitoring control block 110c determines whether or not the equipment ID, the model name, and the generation date/time have been received from the printer PRT1 (Step S302), and when the equipment ID, the model name, and the generation date/time have been received, then a determination is made as to whether or not the model name that has been received matches the model name that is listed for the equipment ID “A001” in the master database 120a (Step S304).

As is shown in FIG. 4, because the model name that is listed in the equipment ID “A001” record in the master database 120a is “LP-9200B,” the monitoring control block 110c determines that there is a match, unlike the case for when the printer body was changed, described above.

When it has been determined that there is a match, the monitoring control block 110c determines whether or not the received generation date/time is earlier than the update date/time that is listed in the received equipment ID record in the master database 120a (Step S308).

As described above, after the details of the agreement have been updated, the update date/time for the equipment ID “A001” is overwritten with “2005/11/5, 14:00” in the master data base 120a. Consequently, the received generation date/time of “2005/8/20, 9:20” is prior to the update date/time, and so the monitoring control block 110c determines that the generation date/time is the earlier of the two.

When the monitoring control block 110c determines that the generation date/time is the earlier of the two in the process in Step S308, then the aforementioned Step S310 is executed to generate a new monitoring setup file MSF.

Specifically, the setup file generating block 110a references the monitoring item table illustrated in FIG. 5 because the service type of the equipment ID “A001” is now “Maintenance, Accounting,” and determines the monitoring items for the maintenance service and the accounting service. In this case, in addition to the monitoring items for the configuration information, the consumable product information, and the alert information, monitoring items for the print job information are also added. Next the setup file generating block 110a references the model information database illustrated in FIG. 6 to determine the OIDs for the model name “LP-9200B” corresponding to the monitoring items that have been determined.

After this, the setup file generating block 110a generates a new monitoring setup file MSF that lists the OIDs that have been determined, and stores the monitoring setup file MSF in the transmission data storage block 130a (Step S310).

After this, the processes in the aforementioned Steps S206 through S208 are performed in the printer PRT1, storing the newly generated monitoring setup file MSF into the monitoring setup file storage block 11b.

The result is that a new monitoring setup file MSF listing the OIDs for the print job information in addition to the OIDs for the configuration information, the consumable product information, and the alert information, will be stored in the monitoring setup file storage block 11b. Consequently, the monitoring information transmission block 10a can acquire print job information from the MIB of the printer body 50 based on this monitoring setup file MSF. The result is that the monitoring information required for the accounting services, including the print job information, will be sent to the monitoring server SV, making it possible to provide maintenance and accounting services with the printer PRT1.

A5. Effects of the Embodiment

As explained above, the monitoring server SV not only identifies the monitoring items suitable for the type of service for the equipment ID according to the master database 120a and the monitoring item table 120c, but also identifies the Object IDs for the monitoring items according to the model name using the model information database 120b. When the printer is turned on, the custom network board CNB sends the model name along with the equipment ID to the monitoring server SV.

Consequently, when the printer body 50 has been replaced with a printer body 60 of a different type, the master control block 10b of the monitoring server SV is able to update the record in the master database 120a by changing the model name listed in the record for the equipment ID that has been sent, changing to the model name of the printer body after the replacement. Moreover, the setup file generating block 110a of the server SV is able to generate a new monitoring setup file MSF in order to provide maintenance services with a printer PRT3 as the target printer based on this updated record.

In addition, the setup file MSF thus generated is sent to the printer PRT3 and stored in the monitoring setup file storage block 11b, making it possible for the monitoring information transmission block 10a to acquire the appropriate monitoring information from the printer body 60, after the replacement, and to send this monitoring information to the monitoring server SV. The result is that the device management service provider is able to continue to provide the maintenance service, using the device management system 1000, even after the printer body has been changed.

Moreover, the update date/time is recorded for each record in the monitoring server SV. When the power supply is turned on for the printer, the custom network board CNB sends the generation date/time the monitoring setup file MSF, which is stored in the monitoring setup file storage block 11b, along with the equipment ID, to the monitoring server SV. If the received generation date/time is earlier than the update date/time, a new monitoring setup file MSF will be generated at the monitoring server SV.

If there has been a change to the details of the agreement, the generation date/time for the monitoring setup file MSF, stored in the monitoring setup file storage block 11b, will be earlier than the update date/time of the applicable record in the master database 120a. Consequently, in this type of configuration, the monitoring server SV can generate a new monitoring setup file MSF according to the details of the agreement after the change, in accordance with the change in the details of the agreement. Additionally, the new monitoring setup file MSF thus generated is sent to the custom network board CNB, and the monitoring information transmission block 10a is able to acquire monitoring information from the MIB of the printer body 50 for the monitoring items depending on the details of the agreement (the service to be provided) after the change.

If the setup file generation block 110a was configured such that the block 110a would generate a new monitoring setup file when there was an update to the master database 120a (FIG. 4), regardless of whether or not an equipment ID or the like was received from the printer PRT1, then a new monitoring setup file MSF would be generated even if the printer PRT1 that had been installed would be removed and the monitoring setup file MSF would not be sent to the printer.

On the other hand, in the present embodiment, the monitoring setup file MSF is generated when the equipment ID and the like has been received from the printer PRT1. Consequently, it is only when a printer PRT1 has been installed and communications are possible that the monitoring setup file MSF is generated in the server SV, and stored in the monitoring setup file storage block 11b in the printer. The result is that the setup file generating block 110a of the server SV is not required to execute excessive processing, thus enabling efficient use of the transmission data storage block 130a.

### B. MODIFIED EXAMPLES

Note that the present invention is not limited to the embodiment described above, but rather may be embodied in a variety of ways without deviating from the spirit or intent to thereof, and may be, for example, modified as described below.

### B1. Modified Example 1

While in the embodiment described above, the monitoring setup file MSF under the initial conditions was stored in the monitoring setup file storage block 11b through an installation technician setting up various information at the time of installation of the printer PRT1, the present invention is not limited thereto. For example, the initial monitoring setup file MSF may be stored by the monitoring setup file generating process described above.

In such a structure, the installation technician does not generate the monitoring setup file MSF after installing the printer PRT1, but rather the monitoring setup file generating process, described above, is started by the power supply of the printer PRT1 being turned on. However, in the master database 120a, the model name is not initially registered in the newly added record after the agreement is entered.

Given this, if there is no model name listed in the record at the time that the monitoring control block 110c in the monitoring server SV determines whether or not the model name received in the process in Step S304 matches the model name listed in the equipment ID record in the master database 120a, then the decision will be that there is no match.

The result is that the monitoring control block 110c in the monitoring server SV determines that the model name does not match in the process in Step S304. Consequently, the processes in Step S306 and Step S310 will be performed, and a monitoring setup file MSF conforming to the model name of the printer PRT1 and the service for which the agreement has been made will be generated and sent to the printer PRT1.

This sort of structure make it possible to eliminate the labor of generating a monitoring setup file MSF through a setup technician inputting monitoring items and storage locations through a setup PC.

### B2. Modified Example 2

While in the embodiment described above, after the master database 120a had been updated because the details of the agreement had been changed, a new monitoring setup file MSF conforming to the type of service, etc. was generated when it was determined in Step S308 that the received generation date/time was prior to the update date/time for the received equipment ID in the master database 120a; however, the present invention is not limited thereto.

For example, even if prior to receiving the generation date/time, etc., from the custom network board CNB, a new monitoring setup file MSF may be generated immediately after the update of the master database 120a, based on the updated master database 120a, the monitoring item table 120c, and the model information database 120b.

When structured in this way, the setup file generating block 110a may store the generated monitoring setup file MSF in a region of the memory 130 other than the transmission data storage block 130a. Moreover, in the monitoring server SV, if the equipment ID, the model name, and the generation date/time have been received from the custom network board CNB, the processes in steps S302 through S308 may be performed. When this is done, in step S308, if the received generation date/time is determined to be prior to the update date/time that is listed in the record for the received equipment ID in the master database 120a, the setup file generating block 110a may store the newly generated monitoring setup file MSF in the transmission data storage block 130a instead of performing the process for generating the monitoring setup file MSF (step S310).

Even in this type of structure, at the time of the periodic polling thereafter, the newly generated monitoring setup file MSF, are sent to the printer PRT1.

### B3. Modified Example 3

In the embodiment described above, the determination of whether or not the generation date/time for the monitoring setup file MSF stored in the printer PRT1 (the monitoring setup file storage block 11b) is prior to the update date/time for the applicable equipment ID in the master database 120a was done by the monitoring server SV (the monitoring control block 110c); however, instead of the monitoring server SV, the printer PRT1 may be caused to make this decision.

Specifically, when, for example, the printer PRT1 is turned on at the start of the workday, the printer PRT1 sends the equipment ID to the monitoring server SV. The monitoring server SV, based on the received equipment ID, extracts the update date/time that is listed in the record for this equipment ID, and stores the extracted update date/time in the transmission data storage block 130a. Thereafter, when this update date/time is sent to the printer PRT1 as a result of the periodic polling, the printer PRT1 determines whether or not the monitoring setup file MSF generation date/time stored in the custom network board CNB is prior to the update date/time received. If the result of this determination is that the generation date/time for the monitoring setup file MSF stored in the custom network board CNB is prior to the received update date/time, then the printer PRT1 1 sends a monitoring setup file generation request, along with the equipment IDs, to the monitoring server SV.

Upon receiving the monitoring setup file generation request and equipment ID from the printer PRT1, the monitoring server SV generates a new monitoring setup file MSF based on the record for the equipment ID in the master database 120a, the monitoring item table, 120c and the model information database 120b, and stores the newly generated monitoring setup file MSF in the transmission data storage block 130a. Given this, the newly generated monitoring setup file MSF will be sent to the printer PRT1 as the result of the periodic polling thereafter. Moreover, the printer PRT1 will erase or delete the monitoring setup file MSF that has already been stored, and will store, in the monitoring setup file storage block 11b, the newly generated monitoring setup file MSF thus received.

Even with this structure, when the service category has changed and the record in the master database 120a has been updated, a new monitoring setup file MSF is generated based on the record after updating, and this monitoring setup file MSF thus generated is sent and stored in the monitoring setup file storage block 11b in the printer PRT1.

In another structure, when the details of the type of service are updated for an individual record in the master database 120a, the monitoring server SV generates a new monitoring setup file MSF based on the updated record in the master database 120a, the monitoring item table 120c, and the model information databasel20b. In this case, the printer PRT1 sends the equipment ID to the monitoring server SV when the power is turned on at the beginning of the workday. Upon receiving the equipment ID from the printer PRT1, the monitoring server SV stores, in the transmission data storage block 130a, the monitoring setup file MSF that is newly generated for the equipment ID.

The newly generated monitoring setup file MSF is then sent to the printer PRT1 as a result of the periodic polling thereafter. The printer PRT1 determines whether or not the generation date/time of the monitoring setup file MSF stored in the custom network board CNB is prior to the generation date/time of the received generated monitoring setup file MSF. If the generation date/time of the monitoring setup file MSF stored in the custom network board CNB is prior to the generation date/time of the received monitoring setup file MSF, then the printer PRT1 erases the existing monitoring setup file MSF, and stores, in the monitoring setup file storage block 11b, the received monitoring setup file MSF; if not, the new monitoring setup file is erased.

Even with the structure, when the type of service is changed so that a record in the master database 120a is updated, a monitoring setup file MSF is generated based on the record after the update, and this generated monitoring setup file MSF is stored in the monitoring setup file storage block 11b of the printer PRT1.

In the above modified structures, CPU 10 of the CNB (FIG. 2) functions as the update time information acquisition section, the time determining section, the decision results transmission section, the acquiring section, the update section, and the erasure section of the device monitoring unit in the claims. The monitoring control block 110c of the server SV (FIG. 3) functions as the decision results receiving section of the setup file generation unit in the claims.

### B4. Modified Example 4

In the embodiment described above, the transmission of the monitoring information, acquired from the MIB to the monitoring server SV, and the periodic polling are performed by the custom network board CNB (the monitoring information transmission block 10a and the polling block 10b); however, the present invention is not limited thereto. For example, a network interface card that is separate from the custom network board CNB may be installed in the printer PRT1, and this network interface card may perform the transmission of the monitoring information and the periodic polling.

### B5. Modified Example 5

While in the embodiment described above the printer controller 30 stored various information regarding the printer body 50 in the memory 11 as the MIB, this information may be stored in a different format instead of the MIB. In such case, the model information database 120b may include, instead of the Object IDs, storage locations or addresses of the memory for the various monitoring information associated with each model name.

### B6. Modified Example 6

While in the embodiment described above, there were no direct relations established between the equipment IDs and the monitoring items, but rather the “service type” was used as a key in establishing their relations using the master database 120a and the monitoring item table 120c, the present invention is not limited thereto. Instead, direct relationships may be established between the equipment IDs and the monitoring items through listing the monitoring items in each record of the equipment IDs in the master database 120a.

### B7. Modified Example 7

While in the embodiment described above, the monitoring information transmission block 10a sends to the monitoring server SV the generation date/time of the monitoring setup file MSF stored in the monitoring setup file storage block 11b, the block 10a may selectively send the generation date/time or a date/time set by the user.

Specifically, the user may store a desired date/time in the memory 11 of the custom network board CNB. After this, when the monitoring setup file generating process is started, first the monitoring information transmission block 10a determines whether or not a date/time is stored in the memory 11. Next, if the monitoring information transmission block 10a has determined that a date/time is stored in the memory 11, then, instead of Step S202 in the embodiment described above, the equipment ID is read out from the default setup data storage block 11a, the model name is read out from the model name storage block 32 of the printer body 60, and the date/time stored in the memory 11 is read out, and all are sent to the monitoring server SV.

If it has determined that there is no date/time stored in the memory 11, then the process in Step S202 in the embodiment described above may be performed as is.

Structuring in this way makes it possible for the user to record, into the memory 11, a desired date/time that is substantially later than the date/time on which the applicable record is updated, and so as to prevent the overwriting of the monitoring setup file MSF that already exists in the printer PRT1 with the newly created monitoring setup file MSF immediately after the applicable record is updated.

The result is that if the date/time at which the provision of service according to the updated agreement details is due to start is substantially later, first the applicable record is only updated in the master database 120a, and then later the user may delete the date/time from the memory 11 with timing according to the date/time at which the provision of service is due to start, making it possible for the monitoring setup file MSF that already exists in the printer to be overwritten at that time with the new monitoring setup file MSF.

### B8. Modified Example 8

While in the embodiment described above the monitoring setup file generating process was started in the custom network board CNB when the power supply to the printer has been turned on, the present invention is not limited to when the power supply is turned on, but rather may be started each time the periodic polling is performed.

In this case, if the polling interval is relatively short, then, when compared to starting the monitoring setup file generating process when the power supply is turned on at the start of work each day, the new setup file after the details of the agreement have been updated will be sent to the target printer more quickly, making it possible to reflect the updated agreement details more quickly.

### B9. Modified Example 9

While in the embodiment described above, the monitoring items associated with the accounting service includes all of the monitoring items associated with the maintenance service, instead the configuration may be such that a portion of the items are replicated, or such that all of the items are replicated.

### B10. Modified Example 10

While in the embodiment described above, the device that is subjected to the maintenance service or the accounting service is a printer, the present invention is applicable to other devices, such as a scanner and a network storage device.

### B11. Modified Example 11

A portion of the structure achieved in software in the embodiment described above may be replaced with hardware. For example, in the monitoring server SV, the monitoring processes performed by the monitoring control block 110c may instead be performed in hardware.

What is claimed is:

1. A setup file generating system comprising:
a device monitoring unit configured to monitor a target device according to a monitoring setup file; and
a setup file generating unit, coupled to the device monitoring unit via a network, for generating the monitoring setup file, the device monitoring unit including:
an information transmission section configured to transmit, to the setup file generating unit, first information held in the device monitoring unit, and second information held in the target device, the setup file generating unit including:
an information receiving section configured to receive the first and second information from the device monitoring unit; and
a setup file generation executing section configured to generate a monitoring setup file based on the received first and second information.

2. The setup file generating system according to claim 1, wherein
the information transmission section autonomously sends the first and second information to the setup file generating unit.

3. The setup file generating system according to claim 1, wherein
the first information includes service agreement identification information for identifying, at least, service agreements; and
the second information includes device model information indicating, at least, the model of the target device.

4. The setup file generating system according to claim 3, wherein
the setup file generating unit further includes:
a table storage for storing a first table that indicates a correspondence relationship between the service agreement identification information and monitoring items to be monitored, and a second table indicating the correspondence relationship between the device model information and storage locations of the monitoring items; and
a storage location determining section configured to determine the monitoring items based on the received service agreement identification and the stored first table, and to determine the storage locations of the monitoring items to be monitored, based on the received device model information and the stored second table,
wherein the setup file generation executing unit generates a monitoring setup file that includes, at least, information indicating the determined storage locations of the monitoring items.

5. The setup file generating system according to claim 4, wherein
the first information further includes generation time information indicating a time at which the monitoring setup file stored in the target device was generated,
the setup file generating unit further includes:
an update time information storage for storing update time information indicating an update time at which at least one of the first table and the second table has been updated; and
a time determining section configured to determine which, of the update time indicated by the update time information, or the generation time indicated by the received generation time information, is more recent,
wherein the setup file generation executing unit generates a monitoring setup file when the update time is determined to be the more recent by the time determining section.

6. The setup file generating system according to claim 4, wherein
the monitoring setup file generating unit records update time information indicating an update time when at least one of the first table and the second table has been updated,
the first information further includes generation time information indicating a generation time of the monitoring setup file stored in the target device,
the device monitoring unit further includes:
an update time information acquisition section configured to acquire the update time information from the setup file generating unit;
a time determining section configured to determine which, of the update time indicated by the acquired update time information or the generation time indicated by the generation time information, is more recent; and
a decision results transmission section configured to transmit to the setup file generating unit, decision results by the time decision section,
wherein the setup file generating unit further includes:
a decision results receiving section configured to receive the decision results from the device monitoring unit,
and wherein the setup file generation executing unit generates a monitoring setup file when the received decision results are that the update time is the more recent.

7. The setup file generating system according to claim 1, wherein the setup file generating unit further includes:
a setup file transmission section configured to transmit to the device monitoring unit the monitoring setup file generated by the setup file generation executing unit.

8. The setup file generating system according to claim 1, wherein
the device monitoring unit is removably attached to the target device.

9. A setup file generating unit coupled via a network to a device monitoring unit that monitors a target device according to a monitoring setup file, comprising:
a receiving section configured to receive, from the device monitoring unit, first information held in the device monitoring unit, and second information held in the target device; and
a setup file generation executing unit configured to generate a monitoring setup file based on the received first and second information.

10. The setup file generating unit according to claim 9, wherein
the first information includes service agreement identification information for identifying, at least, service agreements; and
the second information includes device model information indicating, at least, the model of the target device.

11. The setup file generating unit according to claim 10, further comprising:
a table storage for storing a first table that indicates a correspondence relationship between the service agreement identification information and monitoring items to be monitored, and a second table indicating the correspondence relationship between the device model information and storage locations of the monitoring items; and
a storage location determining section configured to determine the monitoring items based on the received service agreement identification and the stored first table, and to determine the storage locations of the monitoring items to be monitored, based on the received device model information and the stored second table,
wherein the setup file generation executing unit generates a monitoring setup file that includes, at least, information indicating the determined storage locations of the monitoring items.

12. The setup file generating unit according to claim 11, wherein
the first information further includes generation time information indicating a time at which the monitoring setup file stored in the target device was generated,
the setup file generating unit further includes:
an update time information storage for storing update time information indicating an update time at which at least one of the first table and the second table has been updated; and
a time determining section configured to determine which, of the update time indicated by the update time information, or the generation time indicated by the received generation time information, is more recent,
wherein the setup file generation executing unit generates a monitoring setup file when the update time is determined to be the more recent by the time determining section.

13. The setup file generating unit according to claim 9, further comprising:
a setup file transmission section configured to transmit to the device monitoring unit the monitoring setup file generated by the setup file generation executing unit.

14. A device monitoring unit, coupled via a network to a setup file generating unit for generating a monitoring setup file, for monitoring a target device according to the monitoring setup file, comprising:
a storage for storing the monitoring setup file and first generation time information that indicates a generation time of the monitoring setup file;
an acquiring section configured to acquire, from the setup file generating unit, a new monitoring setup file generated newly by the setup file generating unit, and second generation time information indicating a generation time of the new monitoring setup file;
a time determining section configured to determine which, of the generation time indicated by the first generation time information, or the generation time indicated by the second generation time information, is more recent; and
an update section configured to update the monitoring setup file with the new monitoring setup file when the time determining section has determined that the setup time indicated by the second generation time information is the more recent.

15. The device monitoring unit according to claim 14, further comprising
an erasure section configured to erase the new monitoring setup file, acquired from the acquiring section, when the time determining section has determined that the generation time indicated by the first generation time information is the more recent.

16. The device monitoring unit according to claim 14, wherein the device monitoring unit is removably attached to the target device.

17. A method for generating a monitoring setup file used for monitoring a target device in a device monitoring unit, comprising the steps of:
providing a device monitoring unit, and a setup file generating unit coupled to the device monitoring unit via a network;
transmitting, from the device monitoring unit to the setup file generating unit, first information held in the device monitoring unit, and second information held in the target device;
at the setup file generating unit, receiving from the device monitoring unit the first and second information; and
at the setup file generating unit, generating a monitoring setup file based on the received first and second information.

18. A computer program stored on a computer readable medium for generating, in a computer coupled to a device monitoring unit via a network, a monitoring setup file used for monitoring a target device in the device monitoring unit, the computer program comprising:
a first program for causing a computer to receive, from the device monitoring unit, first information stored in the device monitoring unit and second information stored in the target device; and
a second program for causing the computer to generate a monitoring setup file based on the received first and second information.
